(19) United States
(12) Patent Application Publication
(10) Pub. No.: US 2021/0207963 A1
(43) Pub. Date: Jul. 8, 2021

(54) DETERMINATION OF TRAFFIC CHECKPOINT

(71) Applicant: BEIJING BAIDU NETCOM SCIENCE AND TECHNOLOGY CO., LTD., Beijing (CN)

(72) Inventor: Jinzhu Lin, Beijing (CN)

(73) Assignee: BEIJING BAIDU NETCOM SCIENCE AND TECHNOLOGY CO., LTD, Beijing (CN)

(21) Appl. No.: 17/207,543

(22) Filed: Mar. 19, 2021

(30) Foreign Application Priority Data
Aug. 28, 2020 (CN) 202010887671.X

(51) Int. Cl. G01C 21/32; G01C 21/34

(52) U.S. Cl. CPC G01C 21/32; G01C 21/3446; G01C 21/3461

(57) ABSTRACT

A method includes acquiring data of vehicle trajectories within a predetermined area, the predetermined area including an area near and on both sides of a boundary between two adjacent areas; matching the data of the vehicle trajectories with map data within the predetermined area to obtain a matching road network; determining a plurality of intersection points between the road network and the boundary, and dividing the plurality of intersection points into at least one group, a distance between any two intersection points in a first group of the at least one group being less than a preset value; and determining a specific position of a first traffic checkpoint in the first group based on a number of the vehicle trajectories each of the passing intersection points in the first group of the at least one group.

### CROSS REFERENCE TO RELATED APPLICATIONS

This application claims priority to Chinese Patent Application No. 202010887671.X, filed on Aug. 28, 2020, the contents of which are hereby incorporated by reference in their entirety for all purposes.

### TECHNICAL FIELD

The present disclosure relates to the field of computer technologies, and in particular to a method and apparatus for determining a traffic checkpoint, an electronic device, and a medium.

### BACKGROUND

With the continuous development of the social economy and the transportation industry, a growing number of vehicles travel across regions and even borders. During global route planning, a cross-border request needs to be made to a customs port between two countries. However, opening time of the customs port may change over time, and untimely or false update will cause problems such as improper route planning, detours, or failure to get through the port that severely affect user experience.

### SUMMARY

According to an aspect of the present disclosure, a method for determining a traffic checkpoint is provided, the method comprising: acquiring data of vehicle trajectories within a predetermined area, the predetermined area including an area near and on both sides of a boundary between two adjacent areas; matching the data of the vehicle trajectories with map data within the predetermined area to obtain a matching road network; determining a plurality of intersection points between the road network and the boundary, and dividing the plurality of intersection points into at least one group, a distance between any two intersection points in a first group of the at least one group being less than a preset value; and determining a specific position of a first traffic checkpoint in the first group based on a number of the vehicle trajectories passing each of the intersection points in the first group of the at least one group.

According to another aspect of the present disclosure, an electronic device is provided, comprising: a memory storing one or more programs configured to be executed by the one or more processors, the one or more programs including instructions for: acquiring data of vehicle trajectories within a predetermined area, the predetermined area including an area near and on both sides of a boundary between two adjacent areas; matching the data of the vehicle trajectories with map data within the predetermined area to obtain a matching road network; determining a plurality of intersection points between the road network and the boundary, and dividing the plurality of intersection points into at least one group, a distance between any two intersection points in a first group of the at least one group being less than a preset value; and determining a specific position of a first traffic checkpoint in the first group based on a number of the vehicle trajectories passing each of the intersection points in the first group of the at least one group.

According to another aspect of the present disclosure, non-transitory computer-readable storage medium is provided that stores one or more programs comprising instruction that, when executed by one or more processors of an electronic device, cause the electronic device to perform operations comprising: acquiring data of vehicle trajectories within a predetermined area, the predetermined area including an area near and on both sides of a boundary between two adjacent areas; matching the data of the vehicle trajectories with map data within the predetermined area to obtain a matching road network; determining a plurality of intersection points between the road network and the boundary, and dividing the plurality of intersection points into at least one group, a distance between any two intersection points in a first group of the at least one group being less than a preset value; and determining a specific position of a first traffic checkpoint in the first group based on a number of the vehicle trajectories passing each of the intersection points in the first group of the at least one group.

### BRIEF DESCRIPTION OF THE DRAWINGS

The drawings exemplarily show embodiments and form a part of the specification, and are used to explain exemplary implementations of the embodiments together with a written description of the specification. The embodiments shown are merely for illustrative purposes and do not limit the scope of the claims. Throughout the drawings, like reference signs denote like but not necessarily identical elements.

FIG. 1 is a flowchart showing a method for determining a traffic checkpoint according to an embodiment of the present disclosure;

FIG. 2 is a schematic diagram showing a relationship among vehicle trajectories, road networks, and administrative areas according to an embodiment of the present disclosure;

FIG. 3 is a schematic diagram showing a relationship between a boundary and a predetermined area according to an embodiment of the present disclosure;

FIG. 4 is a flowchart showing a method for matching data of vehicle trajectories with map data according to an embodiment of the present disclosure;

FIG. 5 is a schematic structural diagram showing an apparatus for determining a traffic checkpoint according to an embodiment of the present disclosure; and

FIG. 6 is a structural block diagram showing an example electronic device that can be applied to an embodiment of the present disclosure.

### DETAILED DESCRIPTION OF EMBODIMENTS

Embodiments of the present disclosure will be described in more detail below with reference to the accompanying drawings. Although some embodiments of the present disclosure are shown in the accompanying drawings, it should be understood that the present disclosure can be implemented in various forms and should not be construed as being limited to the embodiments set forth herein. On the contrary, these embodiments are provided for a more thorough and complete understanding of the present disclosure. It should be understood that the accompanying drawings and the embodiments of the present disclosure are merely for illustrative purposes, and are not intended to limit the scope of protection of the present disclosure.

It should be understood that the steps recorded in the method implementations of the present disclosure may be performed in different orders and/or in parallel. Furthermore, additional steps may be comprised and/or the execution of the illustrated steps may be omitted in the method implementations. The scope of the present disclosure is not limited in this respect.

Data of the customs port is often updated manually at regular intervals, for example, once a year. However, manually updating data may cause untimely or false update of the data of the customs port, and then cause poorly planned routes, detours, infeasible planning schemes, or other problems.

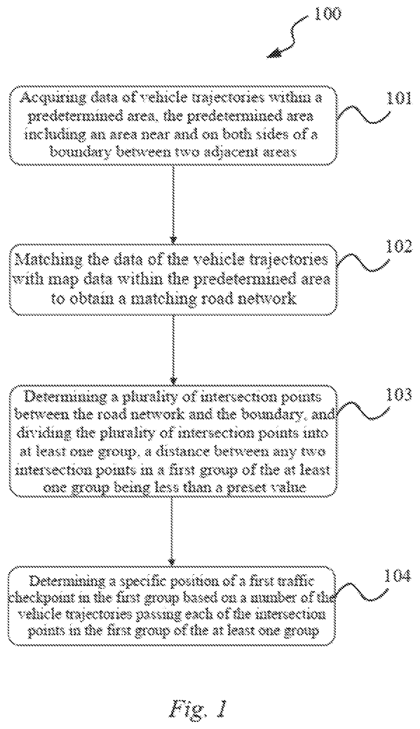

FIG. 1 is a flowchart showing a method 100 for determining a traffic checkpoint according to an embodiment of the present disclosure.

In step 101, acquiring data of vehicle trajectories within a predetermined area, the predetermined area including an area near and on both sides of a boundary between two adjacent areas.

In step 102, matching the data of the vehicle trajectories with map data within the predetermined area to obtain a matching road network.

In step 103, determining a plurality of intersection points between the road network and the boundary, and dividing the plurality of intersection points into at least one group, a distance between any two intersection points in a first group of the at least one group being less than a preset value.

In step 104, determining a specific position of a first traffic checkpoint in the first group based on a number of the vehicle trajectories passing each of the intersection points in the first group of the at least one group.

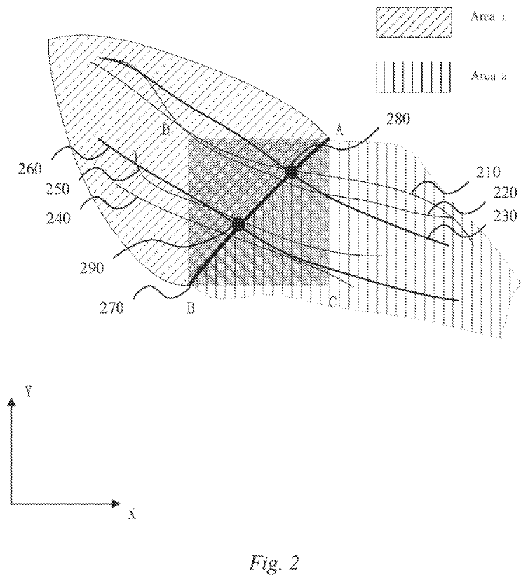

The method 100 for determining a traffic checkpoint according to the embodiment shown in FIG. 1 makes it possible that a specific position of an opening traffic checkpoint can be determined by using the collected data of the vehicle trajectories that is more up-to-date, thereby avoiding untimely or false update of customs port (that is, traffic checkpoint) data that may be caused by manually updating data in the related technologies. Specifically, by matching the data of vehicle trajectories with the real map data, the method 100 according to this embodiment makes it possible to obtain corresponding possible positions of a current traffic checkpoint without a need to manually update data, and select the most possible position therefrom as a position of the current traffic checkpoint. Accurate and timely update of the data of the traffic checkpoint can improve the accuracy of a navigation route, thereby enhancing user navigation experience. FIG. 2 is a schematic diagram showing a relationship among vehicle trajectories, road networks, and administrative areas according to an embodiment of the present disclosure.

As shown in FIG. 2, two adjacent areas: an area 1 and an area 2 are different areas, the area 1 and the area 2 have a boundary 270, and the boundary 270 has an endpoint A and an endpoint B.

Four vehicle trajectories are shown therein, comprising: a vehicle trajectory 210, a vehicle trajectory 220, a vehicle trajectory 240, and a vehicle trajectory 250.

A road network 230 and a road network 260 are preset road networks on a map. There is an intersection point 280 between the road network 230 and the boundary 270, and there is an intersection point 290 between the road network 260 and the boundary 270.

In some embodiments, the predetermined area is determined by performing operations comprising: acquiring coordinates of a plurality of points on the boundary in a first direction and coordinates of the plurality of points in a second direction, the plurality of points being obtained from the boundary with predetermined precision; comparing the coordinates of the plurality of points in the first direction to obtain Xₘₐₓ and Xₘᵢₙ, wherein Xₘₐₓ is a maximum value among the coordinates of the plurality of points in the first direction, and Xₘᵢₙ is a minimum value among the coordinates of the plurality of points in the first direction; and comparing the coordinates of the plurality of points in the second direction to obtain Yₘₐₓ and Yₘᵢₙ, wherein Yₘₐₓ is a maximum value among the coordinates of the plurality of points in the second direction, and Yₘᵢₙ is a minimum value among the coordinates of the plurality of points in the second direction, and determining coordinates of four vertices of the predetermined area as (Xₘᵢₙ, Yₘₐₓ), (Xₘₐₓ, Yₘₐₓ), (Xₘₐₓ, Yₘᵢₙ), and (Xₘᵢₙ, Yₘᵢₙ).

Still referring to FIG. 2, acquiring X coordinates and Y coordinates of the plurality of points on the boundary 270. The plurality of points is obtained with predetermined precision, for example, the X coordinates and Y coordinates of the plurality of points on the boundary 270 are acquired with precision of 1 meter. The X coordinates of the plurality of points on the boundary 270 are compared to find that an X coordinate of a point B is the smallest and an X coordinate of a point A is the largest, and therefore, Xₘₐₓ=X_{A}, and Xₘᵢₙ=X_{B}. The Y coordinates of the plurality of points on the boundary 270 are compared to find that a Y coordinate of the point B is the smallest and a Y coordinate of the point A is the largest, and therefore, Yₘₐₓ=Y_{A}, and Yₘᵢₙ=Y_{B}. Therefore, the coordinates of four vertices of the predetermined area are (X_{B}, Y_{A}), (X_{A}, Y_{A}), (X_{A}, Y_{B}), and (X_{B}, Y_{B}). Correspondingly, the four vertices are D, A, C, and B. Therefore, the predetermined area is determined by an area defined by the four vertices D, A, C, and B.

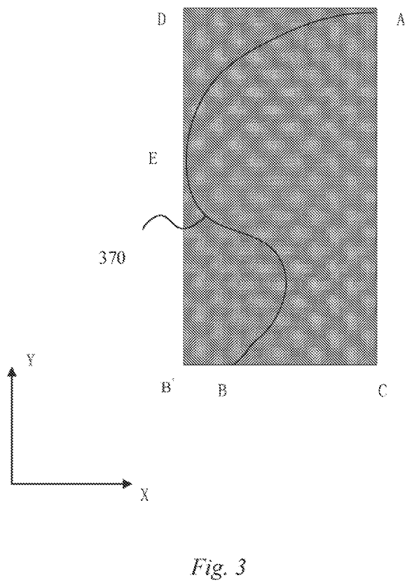

FIG. 3 is a schematic diagram showing a relationship between a boundary and a predetermined area according to an embodiment of the present disclosure.

According to some implementations of the present disclosure, the relationship between the shape of a boundary and a predetermined area is complex. As shown in FIG. 3, acquiring X coordinates and Y coordinates of a plurality of points on a boundary 370. The plurality of points is obtained with predetermined precision, for example, the X coordinates and Y coordinates of the plurality of points on the boundary 370 are acquired with precision of 1 meter. The X coordinates of the plurality of points on the boundary 370 are compared to find that an X coordinate of a point E is the smallest and an X coordinate of a point A is the largest, and therefore, Xₘₐₓ=X_{A}, and Xₘᵢₙ=X_{E}. The Y coordinates of the plurality of points on the boundary 370 are compared to find that a Y coordinate of a point B is the smallest and a Y coordinate of the point A is the largest, and therefore, Yₘₐₓ=Y_{A}, and Yₘᵢₙ=Y_{B}. Therefore, the coordinates of four vertices of the predetermined area are (X_{E}, Y_{A}), (X_{A}, Y_{A}), (X_{A}, Y_{B}), and (X_{E}, Y_{B}). Correspondingly, the four vertices are D, A, C, and B′. Therefore, the predetermined area is determined by an area defined by the four vertices D, A, C, and B′.

In step 101, acquiring data of vehicle trajectories within a predetermined area, the predetermined area being determined by a boundary between two adjacent areas. It can be learned in conjunction with FIGS. 2 and 3 that, the predetermined area is determined by the boundary 270 or the boundary 370 between the two adjacent areas.

Because the predetermined area is determined by the boundary, acquiring the data of the vehicle trajectories within the predetermined area can ensure that the data of the obtained vehicle trajectories are located near the boundary, the obtained data is more effective and accurate, and data of irrelevant vehicle trajectories around is filtered out, thereby reducing the computation amount and improving the computation efficiency.

The data of the vehicle trajectories falling within the predetermined area is collected through collision check.

The boundary is an administrative area boundary between the adjacent areas. The administrative area boundary between the adjacent areas may be a boundary between adjacent provinces or cities. The two adjacent areas may belong to the same country or region. For example, the boundary is a part of the boundary between Shandong Province and Shanxi Province, or a part of a boundary between adjacent cities or counties within the same province. Alternatively, the two adjacent areas may belong to different countries or regions. For example, the boundary is a part of the boundary between Shenzhen and Hong Kong.

In some examples, the traffic checkpoint may be a customs port.

Step 102 is continued. Step 102 of matching the data of the vehicle trajectories with map data within the predetermined area to obtain a matching road network comprises: determining whether a matching degree between the data of the vehicle trajectories and existing road network data in the map data within the predetermined area exceeds a preset matching degree threshold; and considering, in response to determining that the matching degree exceeds the threshold, a current route in the road network as the matching road network route.

The road network is a preset road network on a map.

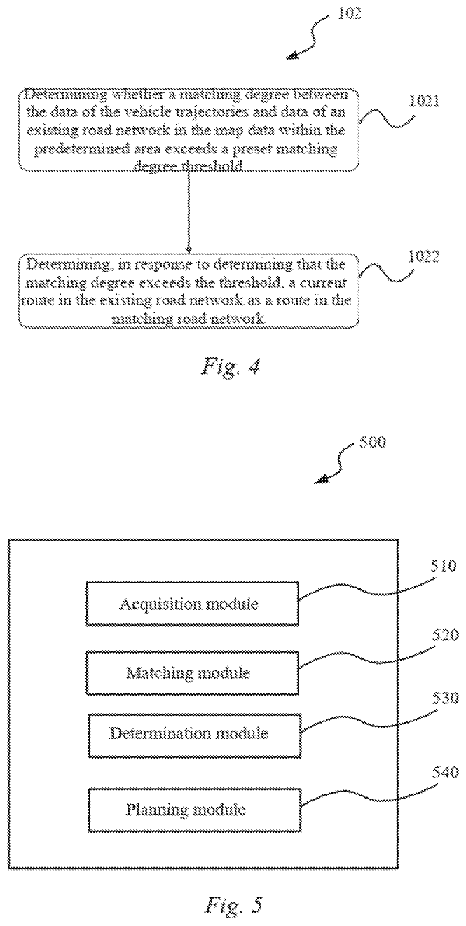

FIG. 4 is a flowchart showing a method for matching data of vehicle trajectories with map data according to an embodiment of the present disclosure.

As shown in FIG. 4, determining whether a matching degree between the data of the vehicle trajectories and data of an existing road network in the map data within the predetermined area exceeds a preset matching degree threshold; and determining, in response to determining that the matching degree exceeds the threshold, a current route in the existing road network as a route in the matching road network. If the matching degree does not exceed the threshold, determining that the current route in the existing road network does not match the vehicle trajectories to be determined.

Since the data of the vehicle trajectories may have errors, the vehicle trajectories may not necessarily coincide with the road network, and the data of the vehicle trajectories needs to be matched with the map data to obtain the matching road network, to determine a road network which a vehicle travels on. The data of the road network has been preset in the map data and has high accuracy, thereby providing an accurate data basis for subsequent computation of the traffic checkpoint.

Each of the vehicle trajectories corresponds to a respective route in the matching road network. As there is definitely a corresponding road for a traveling vehicle, any vehicle trajectory corresponds to a route in a road network.

It may be learned in conjunction with FIG. 2, both the vehicle trajectory 210 and the vehicle trajectory 220 match the road network 230 by using the matching method 102 shown in FIG. 4, and similarly, both the vehicle trajectory 240 and the vehicle trajectory 250 match the road network 260 by using the matching method shown in FIG. 4.

In some examples, the matching method may be the Huffman algorithm.

Step 103 is continued, in which the plurality of intersection points between the matching road network and the boundary are searched, wherein the matching road network comprises a plurality of routes, and the plurality of routes and the boundary intersect to form the plurality of intersection points.

There is a plurality of intersection points between the road network and the boundary. The plurality of intersection points is grouped based on distances between the intersection points, and a plurality of intersection points between which distances are less than a preset value is grouped into one group. The distance between any two intersection points in the group being less than the preset value.

Still referring to FIG. 2, the matching road network comprises the road network 230 and the road network 260. There is an intersection point 280 between the road network 230 and the boundary 270, and there is an intersection point 290 between the road network 260 and the boundary 270.

The intersection point between a route and a boundary represents a position of a traffic checkpoint of two adjacent administrative areas through which a vehicle passes, and if there is a plurality of intersection points, it indicates that there is a plurality of traffic checkpoints on the boundary between the adjacent administrative areas through which the vehicle is allowed to pass. Finding the plurality of traffic checkpoints can provide diversified routes for navigation.

According to some embodiments of the present disclosure, the determining a plurality of intersection points between the road network and the boundary, and dividing the plurality of intersection points into at least one group, a distance between any two intersection points in a first group of the at least one group being less than a preset value comprises: determining the at least one group by means of a depth-first algorithm or a breadth-first algorithm.

In some examples, all the intersection points are traversed once by means of the depth-first algorithm or the breadth-first algorithm, to group intersection points between which distances are less than a threshold into one group, for example, into the first group, a distance between any two intersection points in the first group being less than the preset value.

Still referring to FIG. 2, the intersection point 280 and the intersection point 290 are traversed by means of the depth-first algorithm or the breadth-first algorithm, and if a distance between the intersection point 280 and the intersection point 290 is less than the threshold, the intersection point 280 and the intersection point 290 are grouped into the first group.

The two intersection points in the figure are merely exemplary descriptions, and the present disclosure imposes no limitation on the number of intersection points.

Step 104 is continued, in which a specific position of a first traffic checkpoint in the first group is determined based on a number of the vehicle trajectories passing intersection points in the first group of the at least one group.

The intersection points in the first group are aggregated to determine a traffic checkpoint through which most vehicles pass, and a specific position of the traffic checkpoint is recommended as a navigation route.

According to some implementations of the present disclosure, a number of the vehicle trajectories passing each of the intersection points in the first group within a predetermined time is counted, wherein when the number of vehicle trajectories is greater than a number threshold, traffic checkpoints corresponding to the intersection points in the first group are candidate traffic checkpoints of the first traffic checkpoint.

Still referring to FIG. 2, the numbers of vehicle trajectories passing the intersection point 280 and the intersection point 290 within the predetermined time are counted. For example, the numbers of vehicle trajectories passing the intersection point 280 and the intersection point 290 within one day are counted and are 20 and 30, respectively. When the number threshold is 10, the traffic checkpoints corresponding to the intersection point 280 and the intersection point 290 respectively are both candidate traffic checkpoints.

According to some implementations of the present disclosure, a position of a candidate traffic checkpoint through which most vehicle trajectories pass is selected as the specific position of the first traffic checkpoint.

Still referring to FIG. 2, in some examples, a position of the candidate traffic checkpoint that corresponds to the intersection point 290 and through which most vehicle trajectories pass is selected as the specific position of the first traffic checkpoint.

In some examples, the step of determining the candidate traffic checkpoints may alternatively be omitted. After the number of vehicle trajectories passing each of the intersection points in the first group within the predetermined time is counted, a position of a traffic checkpoint through which most vehicle trajectories pass is directly selected as the specific position of the first traffic checkpoint.

Since there is no need to manually update data of the traffic checkpoint in the process of determining the position of the first traffic checkpoint, a specific position of an opening traffic checkpoint can be acquired by processing the data of the vehicle trajectories, and the position of the traffic checkpoint through which most vehicle trajectories pass is selected as the specific position of the first traffic checkpoint, which indicates that most vehicles have passed through the first traffic checkpoint on the boundary. In this case, it is most possible that the traffic checkpoint is opening, and therefore, directing a navigation route to the first traffic checkpoint will ensure to the greatest extent that a vehicle passes the first traffic checkpoint. When the first traffic checkpoint is a customs port, according to the method for determining a traffic checkpoint provided in the present disclosure, data of the customs port can be automatically updated and user navigation experience can be enhanced.

FIG. 5 is a schematic structural diagram showing an apparatus 500 for determining a traffic checkpoint according to an embodiment of the present disclosure.

As shown in FIG. 5, the apparatus 500 for determining a traffic checkpoint is provided, the apparatus comprising:

an acquisition module 510 configured to acquire data of vehicle trajectories within a predetermined area, the predetermined area including an area near and on both sides of a boundary between two adjacent areas;

a matching module 520 configured to match the data of the vehicle trajectories with map data within the predetermined area to obtain a matching road network;

a determination module 530 configured to determine a plurality of intersection points between the road network and the boundary, and divide the plurality of intersection points into at least one group, a distance between any two intersection points in a first group of the at least one group being less than a preset value; and

a planning module 540 configured to determine a specific position of a first traffic checkpoint in the first group based on a number of the vehicle trajectories passing each of the intersection points in the first group of the at least one group.

Based on the above apparatus for determining a traffic checkpoint, there is no need to manually update data of the traffic checkpoint, data of trajectories within a specific area is acquired, and a specific position of an opening traffic checkpoint can be acquired by processing the data of the vehicle trajectories. There is no need to manually update data during obtaining of the position of the traffic checkpoint, so that the data of the traffic checkpoint can be automatically updated, and the data of the traffic checkpoint can be quickly updated to ensure the accuracy of a navigation route, thereby enhancing user navigation experience.

According to an embodiment of the present disclosure, the present disclosure further provides an electronic device 600 and a readable storage medium.

According to the method for determining a traffic checkpoint, the apparatus, the electronic device, and the medium provided in the present disclosure, data of the customs port can be automatically updated and user navigation experience can be enhanced.

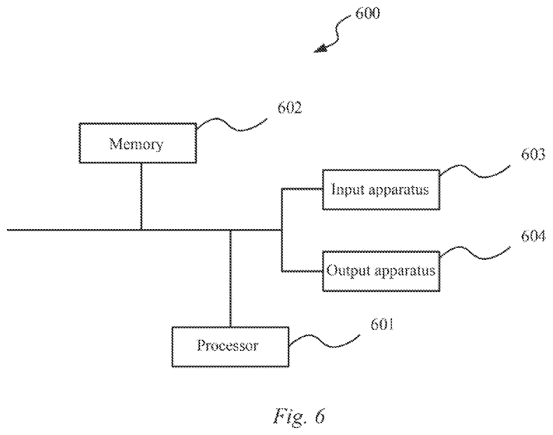

FIG. 6 is a structural block diagram showing an exemplary electronic device that can be applied to an embodiment of the present disclosure.

The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 6, the electronic device 600 comprises: one or more processors 601, a memory 602, and an interface for connecting various components, comprising a high-speed interface and a low-speed interface. The various components are connected to each other by using different buses, and may be mounted on a common motherboard or in other manners as required. The processor may process instructions executed in the electronic device (for example, instructions to display graphical information of the GUI on the display device coupled to the interface). In other implementations, if required, the plurality of processors and/or a plurality of buses can be used together with a plurality of memories. Similarly, a plurality of electronic devices can be connected, and each device provides some of the necessary operations (for example, as a server array, a group of blade servers, or a multi-processor system). In FIG. 6, one processor 601 is used as an example.

The memory 602 is a non-transitory computer-readable storage medium provided in the present disclosure. The memory stores instructions that can be executed by at least one processor, so that the at least one processor performs the method for determining a traffic checkpoint provided in the present disclosure. The non-transitory computer-readable storage medium of the present disclosure stores computer instructions for causing a computer to perform the method for determining a traffic checkpoint provided in the present disclosure.

As a non-transitory computer-readable storage medium, the memory 602 may be configured to store non-transitory software programs, and non-transitory computer-executable programs and modules, such as program instructions/modules corresponding to the method for determining a traffic checkpoint in the embodiments of the present disclosure (for example, the acquisition module 510, the matching module 520, the determination module 530, and the planning module 540 shown in FIG. 5). The processor 601 executes various functional applications and data processing of the server, that is, implements the method for determining a traffic checkpoint in the foregoing method embodiments, by running non-transitory software programs, instructions, and modules stored in the memory 602.

The memory 602 may comprise a program storage area and a data storage area, wherein the program storage area may store an operating system and an application program required by at least one function; and the storage data area can store data created according to the use of the electronic device configured to implement the method for determining a traffic checkpoint. Moreover, the memory 602 may comprise a high-speed random access memory, and may further comprise a non-transitory memory, such as at least one magnetic disk storage device, a flash memory device, or other non-transitory solid-state storage devices. In some embodiments, the memory 602 may optionally comprise memories disposed remotely relative to the processor 601, and these remote memories may be connected, through a network, to the electronic device for implementing the method for determining a traffic checkpoint. Instances of the above network include, but are not limited to, the Internet, an enterprise intranet, a local area network, a mobile communications network, and a combination thereof.

The electronic device 600 for implementing the method for determining a traffic checkpoint may further comprise: an input apparatus 603 and an output apparatus 604. The processor 601, the memory 602, the input apparatus 603, and the output apparatus 604 may be connected through a bus or in other manners. In FIG. 6, the connection using a bus is taken as an example.

The input apparatus 603 can receive entered digit or character information, and generate a key signal input related to user settings and function control of the electronic device for implementing the method for determining a traffic checkpoint, and may be input apparatuses such as a touchscreen, a keypad, a mouse, a trackpad, a touchpad, an indicator rod, one or more mouse buttons, a trackball, and a joystick. The output apparatus 604 may comprise a display device, an auxiliary lighting apparatus (such as an LED), a tactile feedback apparatus (such as a vibration motor), etc. The display device may include, but is not limited to, a liquid crystal display (LCD), a light-emitting diode (LED) display, and a plasma display. In some implementations, the display device may be a touchscreen.

Various implementations of the systems and technologies described herein can be implemented in a digital electronic circuit system, an integrated circuit system, an ASIC (application-specific integrated circuit), computer hardware, firmware, software, and/or a combination thereof. These various implementations may comprise: the systems and technologies are implemented in one or more computer programs, wherein the one or more computer programs may be executed and/or interpreted on a programmable system comprising at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

These computing programs (also referred to as programs, software, software applications, or code) comprise machine instructions of a programmable processor, and can be implemented by using an advanced procedure and/or object-oriented programming languages, and/or assembly/machine languages. As used herein, the terms “machine-readable medium” and “computer-readable medium” refer to any computer program product, device, and/or apparatus (for example, a magnetic disk, an optical disc, a memory, a programmable logic device (PLD)) configured to provide machine instructions and/or data to a programmable processor, comprising a machine-readable medium that receives machine instructions as machine-readable signals. The term “machine-readable signal” refers to any signal used to provide machine instructions and/or data to a programmable processor.

In order to provide interaction with a user, the systems and technologies described herein can be implemented on a computer which has: a display apparatus (for example, a CRT (cathode-ray tube) or an LCD (liquid crystal display) monitor) configured to display information to the user; and a keyboard and pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, voice input, or tactile input).

The systems and technologies described herein can be implemented in a computing system (for example, as a data server) comprising a backend component, or a computing system (for example, an application server) comprising a middleware component, or a computing system (for example, a user computer with a graphical user interface or a web browser through which the user can interact with the implementation of the systems and technologies described herein) comprising a frontend component, or a computing system comprising any combination of the backend component, the middleware component, or the frontend component. The components of the system can be connected to each other through digital data communication (for example, a communications network) in any form or medium. Examples of the communications network comprise: a local area network (LAN), a wide area network (WAN), and the Internet.

A computer system may comprise a client and a server. The client and the server are generally far away from each other and usually interact through a communications network. A relationship between the client and the server is generated by computer programs running on respective computers and having a client-server relationship with each other. The server may be a server in a distributed system, or a server combined with a blockchain. The server may alternatively be a cloud server, or an intelligent cloud computing server or intelligent cloud host with artificial intelligence technologies.

It should be understood that steps may be reordered, added, or deleted based on the various forms of procedures shown above. For example, the steps recorded in the present application can be performed in parallel, in order, or in a different order, provided that the desired result of the technical solutions disclosed in the present disclosure can be achieved, which is not limited herein.

The specific implementations above do not constitute a limitation on the protection scope of the present disclosure. Those skilled in the art should understand that various modifications, combinations, sub-combinations, and replacements can be made according to design requirements and other factors. Any modifications, equivalent replacements, improvements, etc. within the spirit and principle of the present disclosure shall fall within the protection scope of the present disclosure.

1. A method comprising:
acquiring data of vehicle trajectories within a predetermined area, the predetermined area including an area near and on both sides of a boundary between two adjacent areas;
matching the data of the vehicle trajectories with map data within the predetermined area to obtain a matching road network;
determining a plurality of intersection points between the road network and the boundary, and dividing the plurality of intersection points into at least one group, a distance between any two intersection points in a first group of the at least one group being less than a preset value; and
determining a specific position of a first traffic checkpoint in the first group based on a number of the vehicle trajectories passing each of the intersection points in the first group of the at least one group.

2. The method according to claim 1, wherein the predetermined area is determined by performing operations comprising:
acquiring coordinates of a plurality of points on the boundary in a first direction and coordinates of the plurality of points in a second direction, the plurality of points being obtained from the boundary with predetermined precision;
comparing the coordinates of the plurality of points in the first direction to obtain Xₘₐₓ and Xₘᵢₙ, wherein Xₘₐₓ is a maximum value among the coordinates of the plurality of points in the first direction, and Xₘᵢₙ is a minimum value among the coordinates of the plurality of points in the first direction;
comparing the coordinates of the plurality of points in the second direction to obtain Yₘₐₓ and Yₘᵢₙ, wherein Yₘₐₓ is a maximum value among the coordinates of the plurality of points in the second direction and Yₘᵢₙ is a minimum value among the coordinates of the plurality of points in the second direction, and
determining coordinates of four vertices of the predetermined area as (Xₘᵢₙ, Yₘₐₓ), (Xₘₐₓ, Yₘₐₓ), (Xₘₐₓ, Yₘᵢₙ), and (Xₘᵢₙ, Yₘᵢₙ).

3. The method according to claim 2, wherein the matching the data of the vehicle trajectories with map data within the predetermined area to obtain a matching road network comprises:
determining whether a matching degree between the data of the vehicle trajectories and data of an existing road network in the map data within the predetermined area exceeds a preset matching degree threshold; and
determining, in response to determining that the matching degree exceeds the threshold, a current route in the existing road network as a route in the matching road network.

4. The method according to claim 3, wherein each of the vehicle trajectories corresponds to a respective route in the matching road network.

5. The method according to claim 1, wherein the determining a plurality of intersection points between the road network and the boundary comprises:
searching for the plurality of intersection points between the matching road network and the boundary, wherein the matching road network comprises a plurality of routes intersecting the boundary to form the plurality of intersection points.

6. The method according to claim 1, wherein the plurality of intersection points is divided into the at least one group by means of a depth-first algorithm or a breadth-first algorithm.

7. The method according to claim 1, wherein the determining a specific position of a traffic checkpoint in the first group based on a number of the vehicle trajectories passing each of the intersection points in the first group of the at least one group comprises:
counting the number of the vehicle trajectories passing each of the intersection points in the first group within a predetermined time;
in accordance with a determination that the number of the vehicle trajectories passing each of the intersection points in the first group is greater than a number threshold, determining traffic checkpoints corresponding to the intersection points in the first group are candidate traffic checkpoints of the first traffic checkpoint; and
selecting a position of one of the candidate traffic checkpoints through which most vehicle trajectories pass as the specific position of the first traffic checkpoint.

8. The method according to claim 1, wherein the first traffic checkpoint is a customs port, and the two adjacent areas belong to different countries or regions.

9. An electronic device, comprising:
a memory storing one or more programs configured to be executed by the one or more processors, the one or more programs including instructions for:
acquiring data of vehicle trajectories within a predetermined area, the predetermined area including an area near and on both sides of a boundary between two adjacent areas;
matching the data of the vehicle trajectories with map data within the predetermined area to obtain a matching road network;
determining a plurality of intersection points between the road network and the boundary, and dividing the plurality of intersection points into at least one group, a distance between any two intersection points in a first group of the at least one group being less than a preset value; and
determining a specific position of a first traffic checkpoint in the first group based on a number of the vehicle trajectories passing each of the intersection points in the first group of the at least one group.

10. The electronic device according to claim 9, wherein the predetermined area is determined by performing operations comprising:
acquiring coordinates of a plurality of points on the boundary in a first direction and coordinates of the plurality of points in a second direction, the plurality of points being obtained from the boundary with predetermined precision;
comparing the coordinates of the plurality of points in the first direction to obtain Xₘₐₓ and Xₘᵢₙ, wherein Xₘₐₓ is a maximum value among the coordinates of the plurality of points in the first direction, and Xₘᵢₙ is a minimum value among the coordinates of the plurality of points in the first direction; and
comparing the coordinates of the plurality of points in the second direction to obtain Yₘₐₓ and Yₘᵢₙ, wherein Yₘₐₓ is a maximum value among the coordinates of the plurality of points in the second direction and Yₘᵢₙ is a minimum value among the coordinates of the plurality of points in the second direction, and
determining coordinates of four vertices of the predetermined area as (Xₘᵢₙ, Yₘₐₓ), (Xₘₐₓ, Yₘₐₓ), (Xₘₐₓ, Yₘᵢₙ), and (Xₘᵢₙ, Yₘᵢₙ).

11. The electronic device according to claim 10, wherein the matching the data of the vehicle trajectories with map data within the predetermined area to obtain a matching road network comprises:
determining whether a matching degree between the data of the vehicle trajectories and data of an existing road network in the map data within the predetermined area exceeds a preset matching degree threshold; and
determining, in response to determining that the matching degree exceeds the threshold, a current route in the existing road network as a route in the matching road network.

12. The electronic device according to claim 11, wherein each of the vehicle trajectories corresponds to a respective route in the matching road network.

13. The electronic device according to claim 9, wherein the determining a plurality of intersection points between the road network and the boundary comprises:
searching for the plurality of intersection points between the matching road network and the boundary, wherein the matching road network comprise a plurality of routes intersecting the boundary to form the plurality of intersection points.

14. The electronic device according to claim 9, wherein the plurality of intersection points is divided into the at least one group by means of a depth-first algorithm or a breadth-first algorithm.

15. The electronic device according to claim 9, wherein the determining a specific position of a traffic checkpoint in the first group based on a number of the vehicle trajectories passing each of the intersection points in the first group of the at least one group comprises:
counting the number of the vehicle trajectories passing each of the intersection points in the first group within a predetermined time;
in accordance with a determination that the number of the vehicle trajectories passing each of the intersection points in the first group is greater than a number threshold, determining traffic checkpoints corresponding to the intersection points in the first group are candidate traffic checkpoints of the first traffic checkpoint; and
selecting a position of one of the candidate traffic checkpoints through which most vehicle trajectories pass as the specific position of the first traffic checkpoint.

16. A non-transitory computer-readable storage medium that stores one or more programs comprising instruction that, when executed by one or more processors of an electronic device, cause the electronic device to perform operations comprising:
acquiring data of vehicle trajectories within a predetermined area, the predetermined area including an area near and on both sides of a boundary between two adjacent areas;
matching the data of the vehicle trajectories with map data within the predetermined area to obtain a matching road network;
determining a plurality of intersection points between the road network and the boundary, and dividing the plurality of intersection points into at least one group, a distance between any two intersection points in a first group of the at least one group being less than a preset value; and
determining a specific position of a first traffic checkpoint in the first group based on a number of the vehicle trajectories passing each of the intersection points in the first group of the at least one group.

17. The non-transitory computer-readable storage medium according to claim 16, wherein the predetermined area is determined by operations comprising:
acquiring coordinates of a plurality of points on the boundary in a first direction and coordinates of the plurality of points in a second direction, the plurality of points being obtained from the boundary with predetermined precision;
comparing the coordinates of the plurality of points in the first direction to obtain Xₘₐₓ and Xₘᵢₙ, wherein Xₘₐₓ is a maximum value among the coordinates of the plurality of points in the first direction, and Xₘᵢₙ is a minimum value among the coordinates of the plurality of points in the first direction; and
comparing the coordinates of the plurality of points in the second direction to obtain Yₘₐₓ and Yₘᵢₙ, wherein Yₘₐₓ is a maximum value among the coordinates of the plurality of points in the second direction and Yₘᵢₙ is a minimum value among the coordinates of the plurality of points in the second direction, and
determining coordinates of four vertices of the predetermined area as (Xₘᵢₙ, Yₘₐₓ), (Xₘₐₓ, Yₘₐₓ), (Xₘₐₓ, Yₘᵢₙ), and (Xₘᵢₙ, Yₘᵢₙ).

18. The non-transitory computer-readable storage medium according to claim 17, wherein the matching the data of the vehicle trajectories with map data within the predetermined area to obtain a matching road network comprises:
determining whether a matching degree between the data of the vehicle trajectories and data of an existing road network in the map data within the predetermined area exceeds a preset matching degree threshold; and
determining, in response to determining that the matching degree exceeds the threshold, a current route in the existing road network as a route in the matching road network.

19. The non-transitory computer-readable storage medium according to claim 16, wherein the determining a plurality of intersection points between the road network and the boundary comprises:
searching for the plurality of intersection points between the matching road network and the boundary, wherein the matching road network comprise a plurality of routes intersecting the boundary to form the plurality of intersection points.

20. The non-transitory computer-readable storage medium according to claim 16, wherein the determining a specific position of a traffic checkpoint in the first group based on a number of the vehicle trajectories passing each of the intersection points in the first group of the at least one group comprises:
counting the number of the vehicle trajectories passing each of the intersection points in the first group within a predetermined time;
in accordance with a determination that the number of the vehicle trajectories passing each of the intersection points in the first group is greater than a number threshold, determining traffic checkpoints corresponding to the intersection points in the first group are candidate traffic checkpoints of the first traffic checkpoint; and
selecting a position of one of the candidate traffic checkpoints through which most vehicle trajectories pass as the specific position of the first traffic checkpoint.
